(19) United States
(12) Patent Application Publication
(10) Pub. No.: US 2002/0098267 A1
(43) Pub. Date: Jul. 25, 2002

(54) Filled snacks

(75) Inventors: Jacqueline Conrad Heisey, Cincinnati, OH (US); Donna Sue Lohr, Cincinnati, OH (US); Benito Alberto Romanach, Mason, OH (US); Vincent York-Leung Wong, Hamilton, OH (US); Richard Joseph Sackenheim, Hamilton, OH (US); James Earl Trout, West Chester, OH (US); Dennis Paul Kirkpatrick, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Co.

(21) Appl. No.: 09/982,004

(22) Filed: Oct. 18, 2001

Related U.S. Application Data
(60) Provisional application No. 60/242,460, filed on Oct. 23, 2000.

(51) Int. Cl. A21D 13/00

(52) U.S. Cl. 426/94; 426/549; 426/499

(57) ABSTRACT

Filled snacks, particularly filled snacks having creamy lipid-based fillings and crispy-crunchy shells. The creaminess of the filling is maintained even though it is subjected to heat during co-baking with the shell. In one embodiment, the filled snack comprises: (a) an outer shell of from about 0.07 to about 0.3 inches after baking; and (b) a lipid-based filling having a viscosity of less than about 10,000 cP before baking. In a preferred embodiment, a lipid-based nut filling is prepared from a process comprising the steps of: (1) providing a nut paste; (2) defatting a first nut paste portion to form a defatted nut flour; (3) milling the defatted nut flour to form a mono-modal nut solids flour; and (4) refatting the mono-modal nut solids flour to form the nut filling by combining the mono-modal nut solids flour with a re-fatting ingredient selected from the group consisting of added oil, a second nut paste portion, or mixtures thereof.

### CROSS REFERENCE TO RELATED APPLICATIONS

This application claims the benefit of priority to U.S. Provisional Application Serial No. 60/242,460, filed Oct. 23, 2000, which is herein incorporated by reference.

### TECHNICAL FIELD

The present invention relates to filled snacks. More specifically, it relates to filled snacks having creamy lipid-based fillings and crispy-crunchy shells.

### BACKGROUND OF THE INVENTION

Filled snack products, such as cheese or peanut butter filled pretzels, are popular snack food items. Preferably, these snacks have a crisp baked outer dough shell and a soft, creamy filling. The dual texture of the snack provides a desirable eating experience to the consumer.

Many current methods for preparing such filled snack products require a two-step process. In the first step, the outer shell is prepared by baking a configured dough. In the second step, the filling is inserted into the baked dough shell. For example, U.S. Pat. No. 4,275,647, issued Jun. 30, 1981 to Chambers et al., describes a tubular center-filled food product having a rigid, friable baked outer shell and a core of edible filling material formed by this two-step process.

In simpler methods, the filling and outer dough shell are combined and then co-baked to form the filled snack product. However, high fat content fillings can melt during baking and release oil into the dough. This can result in a loss in lubricity of the filling. Also, moisture can migrate from the dough to the filling during baking and subsequent storage. This moisture can be detrimental to the filling and lead to a crumbly, stiffer, less desirable texture.

Accordingly, it would be desirable to provide co-baked filled snacks that have a creamy filling and crispy-crunchy shells.

### SUMMARY OF THE INVENTION

The present invention provides filled snacks having creamy fillings and crispy-crunchy shells. The creaminess of the filling is maintained even though it is subjected to heat during co-baking with the shell.

In one embodiment of the present invention, the filled snack comprises:

(a) an outer shell of from about 0.07 to about 0.3 inches after baking; and

(b) a lipid-based filling having a viscosity of less than about 10,000 cP before baking.

The outer shell in one embodiment is made from a dough comprising:

(1) from about 35% to about 74% flour;

(2) from about 0.05% to about 2% leavening;

(3) from about 0% to about 7% added protein, such that the outer shell comprises from about 2% to about 15% total protein; and

(4) from about 25% to about 35% added water.

In a preferred embodiment, the filled snack is a filled pretzel comprising:

(a) an outer shell made from a dough comprising:

(1) from about 50% to about 74% flour;

(2) from about 0.05% to about 2% leavening;

(3) from about 0% to about 7% added protein, such that the outer shell comprises from about 2% to about 15% total protein;

(4) from about 0.01% to about 7% added lipid;

(5) from about 25% to about 35% added water;

(6) from about 0% to about 3% malt;

(7) from about 0% to about 5% emulsifier;

(8) from about 0% to about 5% corn syrup; and

(9) from about 0% to about 10% flavoring; and

(b) a lipid-based filling having a viscosity of less than about 10,000 cP before baking.

The present invention also provides a preferred lipid-based nut filling. This lipid-based nut filling can be made from a process comprising the steps of:

(1) providing a nut paste;

(2) defatting a first nut paste portion to form a defatted nut flour;

(3) milling the defatted nut flour to form a mono-modal nut solids flour; and

(4) refatting the mono-modal nut solids flour to form the nut filling by combining the mono-modal nut solids flour with a re-fatting ingredient selected from the group consisting of added oil, a second nut paste portion, or mixtures thereof.

### DETAILED DESCRIPTION

A. Definitions

As used herein, “lipid-based filling” includes any filling comprising at least about 20% lipid.

As used herein, the term “lipid” refers to edible fatty substances in a general sense, including natural or synthetic fats and oils consisting essentially of triglycerides, such as, for example soybean oil, corn oil, cottonseed oil, sunflower oil, palm oil, coconut oil, canola oil, fish oil, lard and tallow, which may have been partially or completely hydrogenated or modified otherwise, as well as non-toxic fatty materials having properties similar to triglycerides, herein referred to as non-digestible fats, which materials may be partially or fully indigestible. Reduced calorie fats and edible non-digestible fats, oils or fat substitutes are also included in the term. Mixed triglycerides made from medium and long chain saturated and/or unsaturated fatty acids are also included in the term. See, for example, U.S. Pat. No. 5,288,512 to Seiden. Oils that contain medium chain triglycerides can also be used. See, e.g., U.S. Pat. No. 4,863,753 to Hunter et al. Other oils which may be used include a triacylglycerol oil such as liquid Salatrim™ oil (sold under the trade name Benefat™ III by Cultor Food Science, New York, N.Y.).

The term “non-digestible fat” refers to those edible fatty materials that are partially or totally indigestible, e.g., polyol fatty acid polyesters, such as OLEAN™.

While this invention will be generally described in terms of Olestra, it should be readily apparent that other fat substitutes or mixtures thereof could also be utilized in, and are contemplated by, this invention. Mixtures of fats and fat substitutes are also contemplated herein.

By “polyol” is meant a polyhydric alcohol containing at least 4, preferably from 4 to 11 hydroxyl groups. Polyols include sugars (i.e., monosaccharides, disaccharides, and trisaccharides), sugar alcohols, other sugar derivatives (i.e., alkyl glucosides), polyglycerols such as diglycerol and triglycerol, pentaerythritol, sugar ethers such as sorbitan and polyvinyl alcohols. Specific examples of suitable sugars, sugar alcohols and sugar derivatives include xylose, arabinose, ribose, xylitol, erythritol, glucose, methyl glucoside, mannose, galactose, fructose, sorbitol, maltose, lactose, sucrose, raffinose, and maltotriose.

By “polyol fatty acid polyester” is meant a polyol having at least 4 fatty acid ester groups. Polyol fatty acid esters that contain 3 or less fatty acid ester groups are generally digested in, and the products of digestion are absorbed from, the intestinal tract much in the manner of ordinary triglyceride fats or oils, whereas those polyol fatty acid esters containing 4 or more fatty acid ester groups are substantially non-digestible and consequently non-absorbable by the human body. It is not necessary that all of the hydroxyl groups of the polyol be esterified, but it is preferable that disaccharide molecules contain no more than 3 unesterified hydroxyl groups for the purpose of being non-digestible. Typically, substantially all, e.g., at least about 85%, of the hydroxyl groups of the polyol are esterified. In the case of sucrose polyesters, typically from about 7 to 8 of the hydroxyl groups of the polyol are esterified.

The polyol fatty acid esters typically contain fatty acid radicals typically having at least 4 carbon atoms and up to 26 carbon atoms. These fatty acid radicals can be derived from naturally occurring or synthetic fatty acids. The fatty acid radicals can be saturated or unsaturated, including positional or geometric isomers, e.g., cis- or trans-isomers, and can be the same for all ester groups, or can be mixtures of different fatty acids.

Liquid non-digestible oils are also included in the term “lipid.” Liquid non-digestible oils have a complete melting point below about 37° C. include liquid polyol fatty acid polyesters (see Jandacek; U.S. Pat. No. 4,005,195; issued Jan. 25, 1977); liquid esters of tricarballylic acids (see Hamm; U.S. Pat. No. 4,508,746; issued Apr. 2, 1985); liquid diesters of dicarboxylic acids such as derivatives of malonic and succinic acid (see Fulcher; U.S. Pat. No. 4,582,927; issued Apr. 15, 1986); liquid triglycerides of alpha-branched chain carboxylic acids (see Whyte; U.S. Pat. No. 3,579,548; issued May 18, 1971); liquid ethers and ether esters containing the neopentyl moiety (see Minich; U.S. Pat. No. 2,962,419; issued Nov. 29, 1960); liquid fatty polyethers of polyglycerol (See Hunter et al; U.S. Pat. No. 3,932,532; issued Jan. 13, 1976); liquid alkyl glycoside fatty acid polyesters (see Meyer et al; U.S. Pat. No. 4,840,815; issued Jun. 20, 1989); liquid polyesters of two ether linked hydroxypolycarboxylic acids (e.g., citric or isocitric acid) (see Huhn et al; U.S. Pat. No. 4,888,195; issued Dec. 19, 1988); various liquid esterfied alkoxylated polyols including liquid esters of epoxide-extended polyols such as liquid esterified propoxylated glycerins (see White et al; U.S. Pat. No. 4,861,613; issued Aug. 29, 1989; Cooper et al; U.S. Pat. No. 5,399,729; issued Mar. 21, 1995; Mazurek; U.S. Pat. No. 5,589,217; issued Dec. 31, 1996; and Mazurek; U.S. Pat. No. 5,597,605; issued Jan. 28, 1997); liquid esterified ethoxylated sugar and sugar alcohol esters (see Ennis et al; U.S. Pat. No. 5,077,073); liquid esterified ethoxylated alkyl glycosides (see Ennis et al; U.S. Pat. No. 5,059,443, issued Oct. 22, 1991); liquid esterified alkoxylated polysaccharides (see Cooper; U.S. Pat. No. 5,273,772; issued Dec. 28, 1993); liquid linked esterified alkoxylated polyols (see Ferenz; U.S. Pat. No. 5,427,815; issued Jun. 27, 1995 and Ferenz et al; U.S. Pat. No. 5,374,446; issued Dec. 20, 1994); liquid esterfied polyoxyalkylene block copolymers (see Cooper; U.S. Pat. No. 5,308,634; issued May 3, 1994); liquid esterified polyethers containing ring-opened oxolane units (see Cooper; U.S. Pat. No. 5,389,392; issued Feb. 14, 1995); liquid alkoxylated polyglycerol polyesters (see Harris; U.S. Pat. No. 5,399,371; issued Mar. 21, 1995); liquid partially esterified polysaccharides (see White; U.S. Pat. No. 4,959,466; issued Sep. 25, 1990); as well as liquid polydimethyl siloxanes (e.g., Fluid Silicones available from Dow Corning). All of the foregoing patents relating to the liquid nondigestible oil component are incorporated herein by reference. Solid non-digestible fats or other solid materials can be added to the liquid non-digestible oils to prevent passive oil loss. Particularly preferred non-digestible fat compositions include those described in U.S. Pat. No. 5,490,995 issued to Corrigan, 1996, U.S. Pat. No. 5,480,667 issued to Corrigan et al, 1996, U.S. Pat. No. 5,451,416 issued to Johnston et al, 1995 and U.S. Pat. No. 5,422,131 issued to Elsen et al, 1995. U.S. Pat. No. 5,419,925 issued to Seiden et al, 1995 describes mixtures of reduced calorie triglycerides and polyol polyesters that can be used herein but provides more digestible fat than is typically preferred.

The preferred non-digestible fats are fatty materials having properties similar to triglycerides such as sucrose polyesters. OLEAN™, a preferred non-digestible fat, is made by The Procter and Gamble Company. These preferred non-digestible fat are described in Young; et al., U.S. Pat. No. 5,085,884, issued Feb. 4, 1992, and U.S. Pat. No. 5,422,131, issued Jun. 6, 1995 to Elsen et al.

As used herein, “added fat” refers to fat, both digestible and non-digestible, which is added over and above that amount inherently present in the other ingredients.

As used herein, “added protein” refers to protein which is added over and above that amount inherently present in the other ingredients.

As used herein, “added lipid” refers to lipid which is added over and above that amount inherently present in the other ingredients.

As used herein, “added oil” refers to oil, both digestible and non-digestible, which is added over and above that amount inherently present in the other ingredients.

As used herein, the term “added water” refers to water which is added to the dry dough ingredients. Water which is inherently present in the dry dough ingredients, such as in the case of the sources of flour and starches, is not included in the added water. The amount of added water includes any water used to dissolve or disperse ingredients and includes water present in corn syrups, etc. For example, if ingredients such as maltodextrin or corn syrup solids are added as a solution or syrup, the water in the syrup or solution is included as “added water”.

As used herein, “nut paste” means a suspension of nut solids and oil resulting from the milling of nuts, wherein such milling ruptures the nut oil cells.

As used herein, the term “defatted” means that some oil or fat has been removed. “Defatted nut solids” means nut solids that have had some of their oil or fat removed.

As used herein, “peanut flour” is a flowable solid that is obtained by defatting peanut paste by via a mechanical process or a solvent extraction process to make a cake, followed by milling the cake into a granular powder.

As used herein, “nut solids” are the fat free nut solids (nut solids on a fat-free basis).

As used herein “mono-modal” refers to a particle size distribution of solids having essentially a single peak. A “peak” is a local maxima which is at least 2 weight percent units greater than the local minima on either side of the local maxima. As used herein, “multi-modal” or “poly-modal” refers to a particle size distribution curve having multiple peaks.

As used herein, “D₉₀” is the diameter of the ninetieth (90th) percentile particles, i.e. 90% of the particles in a sample have a smaller particle size than the size indicated. “D₅₀” is defined in a similar manner and represents the fiftieth (50th) percentile particles.

All percentages herein are by weight unless otherwise specified.

B. Outer Shell Dough Formulation

Any suitable dough composition can be used to form the outer shell of the present invention. Flour is present in the dough compositions at a level of from about 35% to about 74%, preferably from about 45% to about 72%, and more preferably from about 50% to about 70%. Preferably, at least about 40% of the flour is wheat flour. Other flours which also may be used include barley flour, rye flour, oat flour, corn flour and mixtures thereof, either alone or in combination with the wheat flour.

A leavening agent is included in the dough compositions of the present invention. The preferred leavening agent is yeast. Other leavening agents, however, may be used. Examples of other leavening agents suitable for use in the present invention include sodium aluminum phosphate, alkali metal carbonates, hydrogen carbonates (e.g. sodium bicarbonate, sodium or potassium carbonate, calcium carbonate), and mixtures thereof.

The dough compositions of the present invention comprise from about 0.05% to about 2%, preferably from about 0.07% to about 1.5%, and more preferably from about 0.08% to about 1%, leavening. When active yeast is used as the leavening, the level of leavening in the dough is typically in the range of from about 0.05% to about 2%, preferably from about 0.07% to about 1%, and more preferably from about 0.08% to about 0.5%.

The dough compositions of the present invention comprise from about 2% to about 15%, preferably from about 3% to about 10%, and more preferably from about 4% to about 8%, protein. Flour having an adequate protein level can be used. Alternatively, added protein can be included in the dough composition to supplement the level of protein found inherently in the flour.

The dough compositions of the present invention comprise from about 0% to about 7% added protein. (“Added protein” is that protein added to the dough composition over and above that amount inherently present in the flour.) The added protein functions to provide adhesive action promoting elasticity, cohesiveness, and binding activity in the dough compositions. Any protein source which will provide one or more of these characteristics may be used in accordance with the dough of the present invention as the added protein. The added protein is preferably derived from a cereal grain, for example, wheat gluten, corn gluten, rye protein, barley, or mixtures thereof. A preferred added protein, providing desirable elasticity and adhesion, is wheat gluten.

The dough compositions of the present invention comprise from about 25% to about 35% added water, more preferably from about 27% to about 33%, and most preferably from about 28.5% to about 31.5%. The term “added water” refers to water which has been added to the dry ingredients. Water which is inherently present in the dry dough ingredients is not included in the term “added water.”

Although the outer shell dough composition will be described primarily in terms of a preferred pretzel dough, it should be readily apparent to one skilled in the art that any suitable dough composition can be used. For example, bread doughs, sweet doughs (i.e. cookie), bagel doughs, and other suitable pretzel doughs can be used in forming the outer shell of the present invention.

The formulation of a preferred pretzel dough is set forth in detail below.

C. Pretzel Dough Formulation

A preferred pretzel dough comprises from about 50% to about 74%, preferably from about 55% to about 72%, and more preferably from about 60% to about 70%, flour. Preferably, at least about 40% of the flour is wheat flour. Other flours which may be used in combination with the wheat flour include barley flour, rye flour, oat flour, corn flour, and mixtures thereof.

The pretzel dough comprises from about 0.05% to about 2%, preferably from about 0.07% to about 1.5%, and more preferably from about 0.08% to about 1%, leavening. The preferred leavening is active yeast. Any other suitable leavening agents, however, can be used. Examples of other leavening agents include sodium aluminum phosphate, alkali metal carbonates, hydrogen carbonates (e.g. sodium bicarbonate, sodium or potassium carbonate, calcium carbonate), and mixtures thereof. When active yeast is used as the leavening, the level of leavening in the dough is typically in the range of from about 0.05% to about 2%, preferably from about 0.07% to about 1%, and more preferably from about 0.08% to about 0.5%.

The pretzel dough comprises from about 0% to about 7% added protein. The added protein is preferably derived from a cereal grain, for example, wheat gluten, corn gluten, rye protein, barley, or mixtures thereof. The preferred added protein for use in the pretzel dough herein is wheat gluten. The pretzel dough comprises from about 2% to about 15%, preferably from about 3% to about 10%, and more preferably from about 4% to about 8%, protein.

The pretzel dough comprises from about 0.01% to about 7%, more preferably from about 0.1% to about 4%, and most preferably about 2%, added lipid. Suitable lipids include fats such as, for example, soybean oil, corn oil, cottonseed oil, sunflower oil, palm oil, coconut oil, canola oil, fish oil, lard, and tallow, which may have been partially or completely hydrogenated or modified otherwise (i.e., structured triglycerides), as well as non-digestible fats, reduced calorie fats, fat substitutes, and mixtures thereof.

The pretzel dough of the present invention comprises from about 25% to about 35% added water, more preferably from about 27% to about 33%, and most preferably from about 28.5% to about 31.5%.

Malt can be included in the pretzel dough at a level of from about 0% to about 3%, preferably at a level of from about 0% to about 2%. Malt can be added to supplement and/or alter flavor and texture of the final product.

An emulsifier can be added to the dough composition of the present invention at a level of from about 0% to about 5%, preferably from about 0% to about 2%, and more preferably from about 0.1% to about 0.5%. Preferred emulsifiers include polyglycerol esters, mono- and diglycerides, diacetyl tartaric acid esters of monoglycerides (DATEM), lecithin, and mixtures thereof. Preferably the emulsifier comprises DATEM.

DATEM is a fatty acid ester of glycerine which is esterified with diacetyl tartaric acid and a fatty acid having from about 12 to about 22 carbon atoms. The fatty acid may be saturated or unsaturated. Preferably, the Iodine Value of the DATEM is from about 0 to about 110, more preferably from about 50 to 110, and most preferably from about 70 to about 85. As used herein, “DATEM” can include esters of monoglycerides as well as diglycerides, in addition to mixtures thereof. Preferred brands of DATEM include Panodan SDK™ and Panodan 205 K™ (both available from Danisco Cultor of New Century, Kans.).

Corn syrup can be added to the pretzel dough composition of the present invention at a level of from about 0% to about 5%, preferably from about 0.1% to about 3%, and more preferably from about 1% to about 2%. As used herein, “corn syrup” refers to a hydrolyzed carbohydrate. Typically corn syrups are classified on the basis of dextrose equivalent (DE) value, which is a measurement of the percentage of reducing sugars in the corn syrup, calculated as dextrose, on a dry weight basis. Corn syrup typically has a DE greater than about 20. Corn syrup is available with DE values ranging from about 20 to about 65. The preferred corn syrup has a DE greater than about 40.

Flavoring may be added to the pretzel dough composition. Preferred flavorings include sourdough, mustard, honey, garlic, and onion. Flavoring is typically added to the dough at a level of from about 0% to about 10%, preferably in the range of from about 0.5% to about 2%. The amount of flavoring added will depend upon the concentration of the flavor, type of flavor added, and the taste desired.

D. Lipid-Based Filling Composition

The lipid-based fillings of the present invention have low viscosities. The viscosity of the lipid-based fillings is less than about 10,000 cP (centipoise), preferably from about 100 cP to about 8000 cP, and more preferably from about 1000 cP to about 7500 cP, measured at 6.8 sec⁻¹ and 150° F. (65.6° C.), before baking.

Although the lipid-based filling will be described primarily in terms of a preferred nut filling, it should be readily apparent to one skilled in the art that any suitable lipid-based filling may be used. For example, cheese, chocolate, and other suitable nut fillings can be used as the lipid-based filling of the present invention.

The preparation of two preferred nut fillings is set forth below.

E. Nut Filling—Preferred Embodiment 1

The process for making a preferred nut filling of the present invention comprises the steps of:

(1) providing a nut paste;

(2) defatting a first nut paste portion to form a defatted nut flour;

(3) milling the defatted nut flour to form a mono-modal nut solids flour; and

(4) refatting the mono-modal nut solids flour to form the nut filling by combining the mono-modal nut solids flour with a re-fatting ingredient selected from the group consisting of added oil, a second nut paste portion, or mixtures thereof.

In one embodiment, a non-digestible oil substitute is used as the added oil in step 4; if non-digestible oil is used, the nut filling can have at least about 50% less fat and at least about 33% fewer calories than a comparable full-fat nut filling.

If desired, the nut filling can also comprise one or more optional ingredients.

1. Providing a Nut Paste

The nut filling of the present invention utilizes a nut paste, preferably peanut paste, as a starting material. While the nut filling will be generally described in terms of peanuts and peanut paste, it should be readily apparent that other materials such as almonds, pecans, walnuts, cashews, filberts, macadamia nuts, Brazilians, sunflower seeds, sesame seeds, pumpkin seeds and soybeans could be used to form the nut paste utilized in the present invention. The term “nut” as used herein encompasses these nuts and seeds. Mixtures of these nuts and oil seeds can also be used.

Roasting of the peanuts prior to defatting is key for the development of the desirable nut flavor. Peanuts are preferably roasted to from about a 32 L′ to about a 37 L′ roast color, blanched, color sorted, then milled to form a fluid nut paste.

The nut paste can be formed by any of a number of known methods. For example, the nuts can be roasted and then ground in a conventional grinder or mill such as a Bauer mill to produce a nut paste of pumpable consistency.

2. Defatting a First Nut Paste Portion to Form a Defatted Nut Flour

A first nut paste portion is defatted by conventional methods such as solvent extraction or by mechanical expression or the like. Typically, the first nut paste portion is defatted to a fat content of from about 10% to about 30% when a mechanical press is used and from about 1% to about 33% when a solvent extraction process is employed, to form a defatted nut flour. An example of a mechanical press is a cocoa powder press used in the chocolate industry. Hexane or liquid CO₂ are examples of solvent extraction processes. The fat content of the defatted nut flour herein is typically about 20%.

3. Milling the Defatted Nut Flour to Form a Mono-Modal Nut Solids Flour

The defatted nut flour is then finely milled such that the nut solids have a mono-modal PSD, to form the mono-modal nut solids flour. This may be accomplished by any suitable conventional means such as, for example, the method described in U.S. Pat. No. 5,079,027 issued Jan. 7, 1992 to Wong et. al., herein incorporated by reference. Preferably, the defatted nut flour is processed through a roll refining mill. These mills operate with rolls running at different speeds and at a closed gap (i.e., they are touching each other). A sufficient amount of fluid must be in the solids to provide lubrication as the product passes through the rolls. For best results, the total fat content of the defatted nut flour before milling is preferably from about 15% to about 20%. If desired, a suitable amount of non-digestible fat may optionally be mixed with the defatted nut flour prior to milling in order to bring the total fat content into this range.

In one embodiment, the nut solids in the mono-modal nut solids flour have a mono-modal particle size distribution (“PSD”) with a D₅₀ less than about 15 microns, preferably less than about 10 microns, and more preferably less than about 8 microns; and a D₉₀ less than about 35 microns, preferably less than about 30 microns, and more preferably less than about 18 microns.

The benefit of a mono-modal nut solids PSD on reducing nut filling viscosity is reported in U.S. Pat. Nos. 5,709,209; 5,433,970; and 5,693,357. Milling nut solids to a mono-modal PSD allows for the incorporation of a high level of nut solids in the nut filling without incurring a substantial loss of fluidity. Specifically, more than 34 % fat free nut solids can be used. Surprisingly, the use of mono-modal nut solids also results in an enhancement of peanut flavor perception and is one of the key factors that contributes toward the elimination of the waxy mouth feel that can be found when Olestra is used. The resultant benefit is more nut flavor and reduced ingredient costs.

The nut filling of the present invention comprises from about 25% to about 75%, preferably from about 35% to about 65%, more preferably from about 40% to about 60%, and still more preferably from about 45% to about 55% of the mono-modal nut solids flour.

4. Refatting the Mono-Modal Nut Solids Flour to Form the Nut Filling

The mono-modal PSD nut solids flour is then refatted to form the nut filling by combining with a re-fatting ingredient selected from the group consisting of added oil, a second nut paste portion, or mixtures thereof.

In one embodiment, the added oil used for refatting is a non-digestible oil substitute; if non-digestible oil substitute is used, the nut filling can have at least about 50% less fat and at least about 33% fewer calories than a comparable full-fat nut filling. The preferred non-digestible oil substitute is olestra, preferably Olean® manufactured by the Procter & Gamble Company. (At room temperature, olestra is a semi-solid with a gel-like consistency.) The added oil can also be a mixture of digestible oil and non-digestible oil substitute.

The nut filling can comprise more than about 20%, preferably more than about 25%, and most preferably more than about 30%, of added oil. The nut filling can comprise at least about 5% of a second nut paste portion, preferably from about 5% to about 25%. A mixture of added oil and a second nut paste portion can also be used as the re-fatting ingredient.

The mono-modal PSD nut solids flour and re-fatting ingredient are combined to form the nut filling. Any suitable method of combining can be used. Preferably, the ingredients are placed in a mixing vessel that is jacketed and heated to 150° F., then thoroughly admixed.

If desired, the viscosity of the nut filling can be reduced through high shear mixing, such as through homogenization, to lower the apparent viscosity. Reducing the viscosity in this manner also leads to an increase in nut flavor. It was found that when a non-digestible oil substitute is used, reducing the viscosity is important to achieving a nut filling having a taste that is organoleptically comparable to full fat nut fillings.

Preferably, the finished nut filling has a viscosity of from about 100 cP to about 8000 cP, preferably from about 1000 cP to about 7500 cP, and more preferably from about 2000 cP to about 7000 cP, measured at 150° F. (65.6° C.) and 6.8 sec⁻¹.

5. Optional Ingredients

The nut filling can comprise from about 0% to about 30% of one or more optional ingredients, preferably from about 0% to about 20%. Optional ingredients can be added at any desired suitable step of the process; alternatively, such ingredients can be added to the finished nut filling.

Especially preferred are particulate water soluble solids such as flavorants, flavor enhancers, bulking agents, and mixtures thereof. Without being limited by theory, it is believed that the inclusion of particulate water soluble solids results in a rapid hydration of the nut solids. Consequentially, the peanut flavor release is enhanced and the faster in-mouth dissolution of the water soluble solids helps disperse and/or emulsify the non-digestible oil, which helps reduce waxy mouthfeel.

As used herein, the term “flavorant” refers to agents that contribute to the flavor of the nut filling. These include sweeteners, natural and artificial flavors, and other flavorants that contribute to the flavor of the nut filling, including natural or artificial peanut flavors, roasted flavors, praline/caramel flavors, walnut flavors, almond flavors and flavor compositions. Sweeteners can be selected from sugars, sugar mixtures, artificial sweeteners and other naturally sweet materials. Sugars include, for example, sucrose, fructose, dextrose, honey, high fructose corn syrup, lactose, maltose, and maltose syrups. Preferably, the sweetener will have a sweetness intensity the same or similar to that of sucrose or fructose. Sugars are typically included in the nut fillings of the present invention at a level of from about 0.5 to about 10%, preferably from about 1 to about 7%.

Artificial sweeteners such as aspartame, acesulfam, saccharine, cyclamate and glycerrhizin can also be used in the nut fillings of the present invention. The amount of artificial sweetener used depends on its sweetness intensity. Typically, these artificial sweeteners are included in amount that provides a sweetness intensity equivalent to the addition of from about 0.5 to about 10%, preferably from about 1% to about 7%, sucrose. Usually from about 0.001% to about 2% artificial sweetener is used.

As used herein, “flavor enhancers” refer to agents that enhance or complement the flavor of the nut filling. Flavor enhancers include salt or salt substitutes such as sodium chloride, potassium chloride, sodium chloride/potassium chloride mixtures, and seasoned salts. The level of flavor enhancer used is a matter of the desired taste level, but usually is from about 0.1 to about 2%, preferably from about 0.5 to about 1.5%, of the nut filling.

The nut fillings of the present invention can also comprise from about 0.01% to about 0.02% citric acid as a flavor enhancer. Preferably from about 0.01% to 0.015% citric acid is used. The addition of citric acid can enhance the roasted nut and especially the roasted peanut butter flavor and saltiness impression, thereby reducing the amount of salt required to give the nuts fillings, especially peanut butters, of the present invention an acceptable flavor. The addition of citric acid, especially in the presence of a metallic ion salt, also allows the nut filling to achieve oxidative stability through chelation of the metal ions by the citric acid.

Particularly preferred flavor systems for use in the nut fillings of the present invention are those involving a combination of sugar and salt. For nut fillings using this preferred flavor system, the sugar is typically present in the filling at a level from about 0.5 to about 10%, preferably from about 1 to about 7%; the level of salt is typically present in the filling at a level of from about 0.1 to about 2%, preferably from about 1 to about 1.5%.

Particulate water soluble bulking agents can be used in the nut fillings of the present invention. These bulking agents typically add body or texture to the filling and can be non-nutritive or low calorie materials. Suitable bulking agents include corn syrup solids, maltodextrin, dextrose, polydextrose, mono- and disaccharides, starches (e.g., corn, potato, tapioca wheat), as well as mixtures of these agents. Corn syrup solids, polydextrose (from Pfizer Chemicals) and maltodextrin are preferred bulking agents. Sugar substitutes which function like sugars but which are non-nutritive can also be used herein. Such sugar substitutes include the 5-C-hydroxyalkylaldohexoses described in U.S. Pat. No. 5,041,541 (Mazur), issued Aug. 20, 1991.

In order to minimize grittiness, these particulate water soluble solids preferably have a relatively fine particle size. Particulate water soluble solids included in the nut fillings of the present invention preferably have a mean particle size of about 20 microns or less. Especially preferred particulate water soluble solids have a mean particle size of about 10 microns or less.

Any other suitable optional ingredients may also be used in the nut filling of the present invention.

The nut filling of the present invention may optionally contain a stabilizer. The stabilizer can be any of the known peanut butter stabilizers such as, but not limited to, hydrogenated rapeseed oil or other hydrogenated triglycerides having a high proportion of C₂₀ and C₂₂ fatty acids. (See, for example, U.S. Pat. No. 3,597,230 and U.S. Pat. No. 3,192,102.) Stabilizers are usually triglycerides which are solid at room temperature. They solidify in the nut butter in specific crystalline states and keep the oil from separating. These materials can be mixed with a second hydrogenated oil having an iodine value of less than 8, for example hydrogenated palm oil, canola oil, soybean oil, cottonseed oil, coconut oil, and similar materials. This stabilizer can also be mixed with lower melting fat fractions such as, for example, the peanut butter stabilizer composition disclosed in U.S. Pat. No. 4,341,814 (1982).

In addition to the stabilizer, or in lieu thereof, an emulsifier can be used in the present invention. The emulsifier can be any food compatible emulsifier such as mono- and di-glycerides, lecithin, sucrose monoesters, polyglycerol esters (“PGE”), sorbitan esters, polyethoxylated glycerols, and mixtures thereof. Typically, from about 0% to about 3%, preferably from about 1% to about 3%, stabilizer or emulsifier or a mixture thereof is preferably used.

The present invention can also employ other flavored additives which can be mixed with the nut filling. These additives include nut chunks, chocolate chips or bits or other flavored bits (e.g., butterscotch and peanuts), jellies (either low calorie jellies or regular jelly or preserves), and praline nuts or other candies. These additives are usually added at a level of from about 1% to about 20% by weight. Nut chunks and flavored bits can contain fats and oils. Thus, the addition of these materials can affect the fat content and the calorie level of the nut filling.

Preferred nut chunks can be prepared by milling roasted peanuts. In one embodiment the roasted peanuts are chopped and sized between a No. 7 and No. 20 U.S. Standard sized screen. Use of peanut chunks in this size range is desirable in the making of a low fat peanut filling.

The nut filling can also be fortified with vitamins and/or minerals. These can include, but are not limited to, Vitamin A, Vitamin D, Vitamin K, Vitamin C, Vitamin E, thiamin, riboflavin, niacin, Vitamin B-6, Vitamin B-12, biotin, pantothenic acid, iron, calcium, niacin, magnesium, and mixtures thereof.

Sterols or sterol esters can also be incorporated into the nut filling of the present invention. Preferably, the nut filling contains about 1.8 grams of sterol or sterol ester per serving. Suitable sterol and sterol ester compositions are described in U.S. Pat. No. 3,751,569, issued Aug. 7, 1973 to Erickson; U.S. Pat. No. 5,244,887, issued Sep. 14, 1993 to Straub; U.S. Pat. No. 3,865,939 issued Feb. 11, 1975 to Jandacek et al.; U.S. Pat. No. 3,085,939, issued Apr. 16, 1963 to Wruble; U.S. Pat. No. 5,502,045, issued Mar. 26, 1996 to Miettinen; U.S. Pat. No. 5,958,913, issued Sep. 28, 1999 to Miettinen; and in co-pending P&G Application 8003P, filed Mar. 27, 2000 in the name of Wong et al.

6. Nut Filling Properties

The preferred nut filling has a non-fat solids to total oil ratio of less than 2.0:1, preferably less than 1.5:1. The nut filling has at least about 50% less fat and at least about 33% fewer calories than comparable full-fat nut fillings.

For the desired flavor and protein content, the fat free nut solids typically comprise from about 35 to about 45% of the nut filling. Preferably, the fat free nut solids comprise from about 35% to about 40% of the nut filling. The source of the nut solids can include a combination of full fat peanut paste, full fat peanuts, defatted peanuts, and defatted peanut flour.

Olestra is typically more viscous than the nut oil that it replaces because of olestra's solid component. At ambient temperature, the apparent viscosity of Olestra measured at 6.8 sec⁻¹ is typically about 4350 cP vs. about 50 cP for peanut oil. Because of its gel-like state, using this oil as a peanut oil replacement causes a waxy mouth feel and a suppression of the nut flavor. This effect is most pronounced in nut fillings where the level of peanut solids exceeds 45% and the ratio of non fat solids to total oil exceeds 2.0:1.

Olestra's solid component can cause a waxy sensation in the mouth when ingested. This effect is noticed when olestra is used to replace the nut oil in order to make low fat and calorie nut fillings. The resultant nut fillings have a waxy mouth feel, high stickiness perception and a loss of peanut flavor. The present invention minimizes these problems.

Surprisingly, the use of mono-modal nut solids also results in an enhancement of peanut flavor perception and is one of the key factors that contributes toward the elimination of the waxy mouth feel that can be found when olestra is used. The resultant benefit is more nut flavor and reduced waxy mouth feel.

Surprisingly, increasing the level of nut solids beyond the level in full nut fillings (about 45%) does not result in an increase in peanut flavor. Instead, such products have less peanut flavor as well as an undesirable waxy mouth feel. Without being bound by theory, the rheology of nut fillings are highly impacted by the level and size distribution of the nut solids. With a high level of nut solids, the viscosity of the mix becomes excessively high; this decreases the extent of hydration of the nut solids during mastication. It is believed that peanut flavor volatiles are released when the nut solids are hydrated. Poor mixing in the mouth due to the high viscosity can also lead to poor heat transfer, resulting in a higher level of solid fat and a waxy eating quality.

E. Nut Filling—Preferred Embodiment 2

In another embodiment, a nut filling is prepared by mixing added oil with a nut butter or nut spread to reduce the viscosity to the desired level. Suitable nut fillings or spreads can include commercially available nut butters or spreads, as well as nut butters or spreads such those disclosed in U.S. Pat. No. 5,942,275 issued Aug. 24, 1999, to Wong et al.; U.S. Pat. No. 5,885,646, issued Mar. 23, 1999 to Wong et al.; U.S. Pat. No. 5,885,645, issued Mar. 23, 1999 to Wong et al.; U.S. Pat. No. 5,714,193 issued Feb. 3, 1998 to Fix et al.; U.S. Pat. No. 5,693,357 issued Dec. 2, 1997 to Wong et al.; U.S. Pat. No. 5,667,838 issued Sep. 16, 1997 to Wong et al.; U.S. Pat. No. 5,518,755 issued May 21, 1996 to Wong et al.; U.S. Pat. No. 5,508,057 issued Apr. 16, 1996 to Wong et al.; U.S. Pat. No. 5,490,999, issued Feb. 13, 1996 to Villagran et al.; U.S. Pat. No. 5,433,970 issued Jul. 18, 1995 to Wong et al.; U.S. Pat. No. 5,230,919 issued Jul. 27, 1993 to Walling et al.; U.S. Pat. No. 5,079,027, issued Jan. 7, 1992 to Wong et al.; U.S. Pat. No. 3,265,507, issued Aug. 9, 1966 to Japikse; U.S. Pat. No. 3,129,102 to Sanders; U.S. Pat. No. 1,395,934 issued Nov. 1, 1921 to Stockton; U.S. Pat. No. 2,504,620 issued Apr. 18, 1950 to Avera; U.S. Pat. No. 2,521,243 issued Sep. 5, 1950 to Mitchell; U.S. Pat. No. 2,562,630 issued Jul. 31, 1951 to Mitchell; U.S. Pat. No. 2,552,925 issued May 15, 1951 to Avera; U.S. Pat. No. 6,010,737 issued Jan. 4, 2000 to Meade; co-pending U.S. application Ser. No. 09/511,058 filed Feb. 23, 2000 by Wong et al. entitled “Peanut Butter with Improved Flavor and Texture”; and co-pending U.S. Provisional Application Serial No. 60/192,813 filed Mar. 29, 2000 by Wong et al. entitled “Low Fat Nut Spread Composition with High Protein and Fiber.”

G. Preparing the Filled Snack

The filled snack may be formed by any suitable method that encloses the lipid-based filling inside the outer shell dough. For example, such methods can include extrusion, sheeting and stamp cutting, folding, or forming the dough into a hollow tube to contain the lipid-based filling. After the lipid-based filling is enclosed inside the outer shell dough, the snack is baked to form the finished filled snack. If desired, the snack can be cut into pieces of the desired size and shape either before or after baking; furthermore, the snack can be indented during baking.

Preferably, the filled dough comprises from about 40% to about 80% filling, more preferably from about 45% to about 70% filling, before baking.

The filled dough can be baked at a temperature of from about 200° F. (93.3° C.) to about 650° F. (343.3° C.), and preferably from about 230° F. (110° C.) to about 450° F. (232.2° C.). Any suitable baking process of one or more steps can be used.

Preferably, the average thickness of the outer shell after baking is from about 0.07 to about 0.3 inches, preferably from about 0.08 to about 0.2 inches. This thick outer shell helps to maintain the creaminess of the lipid-based filling. The thicker shell also delivers improved sealing of the filled snacks (fewer leaks).

Two preferred methods for preparing a filled snack involving (1) forming strips and wrapping and (2) co-extrusion are described below. Also described below is the preparation of a preferred filled pretzel.

1. Forming Strips and Wrapping

In one embodiment, the outer shell dough is formed into a continuous flat sheet of dough from about 2 to about 4 inches wide, preferably about 3.75 inches wide. The sheet of dough may be formed by hand, and the entire filling an preparation process may be performed by hand, but for manufacturing on a large scale it is preferred to manufacture by an automated procedure using conventionally available equipment.

Mechanically, the continuous sheets can be produced either by extrusion of dough through a nozzle having the width and thickness of the desired continuous sheet, or by rolling the dough until the desired continuous sheet is produced. The sheets are conveyed along a conveyor belt in the longitudinal direction, i.e., lengthwise. A depositor as commercially available in the bakery art is used to deposit a strand of from about 0.15 inch to about 0.5 inch diameter lipid-based filling, preferably from about 0.2 inch to about 0.4 inch diameter, preferably at room temperature or below, most preferably at from about 20° F. to about 60° F., onto the dough sheet. Precise placement of the lipid-based filling is not critical, but it is preferred that the strand be deposited centrally.

The outer longitudinal edges of the dough sheet are then contacted with one another by folding onto one another, causing the dough sheet to wrap around the lipid-based filling and form a continuous cylinder or tube around the outer lipid-based filling. The contacted edges are fused together by applying pressure to the edges or any other suitable means.

The continuous cylinder preferably proceeds along a conveyer along its longitudinal axis to a cutter. The cutter may be a vertical cross cutter with either a blade or a wire cutter, or a motorized wire guillotine. The continuous cylinder is cut into filled snack pieces of the desired shape.

Alternatively, the continuous tube can be indented during baking to provide for cutting spots and eventually closed pieces. Preferably, the indenting occurs while the continuous tube is pliable and right before losing all pliability to avoid losing the indentation. As used herein, indenting refers to the act of pressing the continuous tube in such a way so as to bring together opposing sections of the tube; this can create individual compartments in the tube that can be separated after baking via breaking, serrating, or other suitable means.

Indenting during baking has several advantages. For instance, this can help to avoid potentially poor sealing of the individual pieces, which can create leaking nuggets. Furthermore, indenting during baking leads to better insulation of the filling from the heat of the oven.

The snack can be baked at a temperature of from about 200° F. (93.3° C.) to about 650° F. (343.3° C.), and preferably from about 230° F. (110° C.) to about 450° F. (232.2° C.). Any suitable baking process of one or more steps can be used.

2. Co-Extrusion

Co-extrusion is a conventional method for fast and economical production of a continuous filled tube. Co-extrusion technology is well known in the art. For example, see U.S. Pat. No. 4,794,009, disclosing a method and apparatus for forming filled dough products; U.S. Pat. No. 4,259,051, disclosing extrusion of a dough tube encasing ketchup or sour cream; U.S. Pat. No. 4,882,185, disclosing a vertical tubular extrusion of bread dough crust material and jam or cream cor material; U.S. Pat. No. 4,251,201, disclosing an apparatus for the preparation of a filled pretzel; U.S. Pat. No. 3,917,863, disclosing an annular food ring; U.S. Pat. No. 3,615,675, disclosing an extruder that produces a dough tube filled with a suitable food material; and U.S. Pat. No. 3,541,009, disclosing a device for forming a cereal shell and simultaneously filling the shell with a filler. Symmetrical and non-symmetrical extrusion products, multi-level co-extrusion products, and multi-material products are within the contemplation of the present invention. Other methods of production of filled dough products are described in U.S. Pat. Nos. 4,794,009 and 4,882,185.

In one embodiment, a first hopper is filled with lipid-based filling and a second hopper is filled with outer shell dough. Either the hoppers are pressurized, or a feed means is provided in feed conduits for conveying the filling and dough to co-extrusion nozzles comprising an internal nozzle and an external nozzle. Extruded from the nozzle is a continuous cylinder with a lipid-based filling core and a tubular outer shell dough. Suitable co-extruders are well known in the art and are described in, for example, U.S. Pat. Nos. 4,882,185, 4,794,009, and 4,251,201. Furthermore, any suitable commercially available co-extruder may be used, such as the CJ System or the CD System co-extruder systems, available from Reading Bakery Systems, Robesonia, Pa., USA.

The continuous tube is deposited upon a conveyor belt where it is conveyed to a cutter and cut into segments, preferably immediately after leaving the nozzle, of preferably from about 0.25 inch to about 9 inches, more preferably from about 0.25 to about 5 inches, and still more preferably from about 0.25 to about 1.5 inches in length. Once the continuous tube is sliced or divided into bite-sized pieces, the pieces are then baked.

Alternatively, the continuous tube can be indented during baking to provide for cutting spots and eventually closed pieces. Preferably, the indenting occurs while the continuous tube is pliable and right before losing all pliability to avoid losing the indentation. As used herein, indenting refers to the act of pressing the continuous tube in such a way so as to bring together opposing sections of the tube; this can create individual compartments in the tube that can be separated after baking via breaking, serrating, or other suitable means.

The snack can be baked at a temperature of from about 200° F. (93.3° C.) to about 650° F. (343.3° C.), and preferably from about 230° F. (110° C.) to about 450° F. (232.2° C.). Any suitable baking process of one or more steps can be used.

3. Filled Pretzel

One embodiment of the present invention is a filled pretzel. Conventional mixing apparatus may be used to prepare the preferred filled pretzels of the present invention. Preferably, the preferred pretzel dough ingredients described above are mixed in a conventional mixer and added to a coextruder. The pretzels may be extruded using conventional pretzel coextruders. Suitable extruders include single unit coextruders available from Reading Bakery Systems, Robesonia, Pennsylvania, USA. A preferred extruder is an extruder which has a die that shapes the dough to the desired shape upon exiting the extruder. For pretzels described herein as exemplary of the present invention, extrusion through a die onto a conveyer is preferred because it permits the continuous forming of filled dough pieces.

Suitable extruders comprise a co-extrusion die for extruding an elongated cylindrical pretzel dough with an inner filling material. The pretzel dough is fed into the outer orifice, while a lipid-based filling is fed into the inner orifice of the coextruder. It is important that the outer dimension of the dough extrusion orifice be of a size such that the resulting pretzel shell is on average from about 0.07 to about 0.3 inches, preferably from about 0.08 to about 0.2 inches, after baking.

After extrusion, the cylindrical pretzel dough may be cut into snack pieces and crimped to seal the ends. The filling must be completely contained within the dough prior to baking. (Alternatively, long ropes of pretzel dough may be baked and then cut into pieces after baking.) The snack pieces (or ropes of pretzel dough) may optionally be allowed to sit stationary on a moving conveyor to “proof.” This “proofing” allows the dough piece to increase in volume while the fermentation reaction between the yeast and other dough ingredients generate ethanol gas and carbon dioxide gas.

After proofing, the dough pieces are treated with a caustic solution having a temperature of from about 70° F. (21.1° C.) to about 250° F. (121.1° C.), preferably from about 150° F. (65.6° C.) to about 210° F. (98.9° C.), and more preferably from about 170° F. (76.7° C.) to about 200° F. (93.3° C.). The caustic solution may be applied to the pretzels by various methods. Preferably the caustic solution is applied to the pretzels by dipping the pretzels in a caustic solution typically comprising from about 0.1% to about 4%, preferably from about 0.5% to about 1.5%, and most preferably from about 0.6% to about 0.8% sodium hydroxide, for less than about 20 seconds, preferably for about 7 seconds to about 10 seconds. The concentration of caustic solution used is dependent on several factors, including: (a) piece size; (b) contact time of the solution with the pretzel; and (c) procedure used to treat the pretzel (e.g., waterfall, spray, dip). It has been found that for preferred embodiments (i.e., pretzels of the present invention having a high ratio of surface area to inner volume), caustic concentrations (˜1%-2%) used in conventional pretzel processing resulted in products having a strong caustic taste and very hard texture.

Alternatively, the dough pieces may be conveyed through a waterfall or an atomized spray zone of hot caustic solution having a plurality of nozzles for uniformly coating the outer surface of the dough pieces. The atomized spray should be sufficient to provide enough thermal heat to set proteins, gelatinize surface starches and activate leavening. If a waterfall is used, a caustic solution comprising from about 2% to about 7%, preferably from about 3% to about 6% and more preferably from about 4% to about 5%, sodium hydroxide is typically used.

Alternatively, the dough may be conveyed as a continuous rope through the caustic solution, baked, then cut into pieces. In one embodiment, the rope is indented during baking.

Following the caustic treatment, the dough pieces are optionally seasoned (i.e., with salt, seasoning, herbs, spices, sugar, or other particulate material) and finally conveyed to an oven where they are baked at a temperature of from about 200° F. (93.3° C.) to about 650° F. (343.3° C.), and preferably from about 230° F. (110° C.) to about 450° F. (232.2° C.). Any suitable baking process of one or more steps can be used. Most preferably, the dough pieces are baked using a two-step process wherein first the dough pieces are carried through a high temperature oven having a temperature of from about 350° F. (176.7° C.) to about 650° F. (343.3° C.) for about 1 to about 20 minutes, preferably from about 7 to about 12 minutes, and next they are conveyed through a lower temperature oven having a temperature of from about 190° F. (87.8° C.) to about 400° F. (204.4° C.), preferably from about 220° F. (104.4° C.) to about 300° F. (148.9° C.), for a time sufficient to obtain a finished filled pretzel snack preferably having a moisture content of less than about 6%.

The filled pretzel can optionally be coated. Any suitable lipid or water based coatings can be used, such as chocolate or yogurt-based coatings. Furthermore, other optional ingredients such as salt, flavoring, and coloring may be included.

### Analytical Methods

Parameters used to characterize elements of the present invention are quantified by particular analytical methods. These methods are described in detail as follows. (All laboratory instruments should be operated according to manufacturers' instructions, as set forth in the instrument operation manuals and/or other instructional materials, unless otherwise indicated.)

1. Fat Content

The method used to measure total fat content (both digestible and non-digestible) is AOAC 935.39 (1997). (AOAC International, Gaithersburg, Md.)

DIGESTIBLE FAT CONTENT

Digestible lipid (NLEA) method AOAC PVM 4:1995, “Capillary Gas Chromatographic Determination of Fat in Olestra Savory Snack Products,” is used to determine digestible fat content. (AOAC International, Gaithersburg, Md.)

NON-DIGESTIBLE FAT CONTENT

Non-Digestible Fat Content=Total Fat Content−Digestible Fat Content

Olestra-Containing Foods-Digestible Fat and Saturated Fat: The content of total digestible fat and total digestible saturated fat of a food is measured according to the published AOAC peer-verified method for quantifying fat in olestra-containing snack foods (AOAC Peer-Verified Method PVM 4:1995, “Capillary Gas Chromatographic Determination of Fat in Olestra Savory Snack Products”, AOAC International, Gaithersburg, Md.).

2. Moisture Content

The moisture content can be determined by a forced air oven volatiles method as follows:

Equipment:

Forced air oven, aluminum tins with lids, Cabinet-type desiccator

Procedure:

1. Weigh tin and lid to 0.0001 grams and record weight as tare weight

2. Place 2-3 gram ground product sample into tin, weigh to 0.0001 grams and record as gross weight

3. Set oven temperature to 105° C.

4. Place tin containing the product sample in oven for 1 hour, uncovered

5. Remove tin containing the sample from the oven, cover the tin, and place in desiccator until cooled to room temperature

6. Weigh tin, lid and dried sample to 0.0001 grams and record as final dried weight

Calculations:

1. Sample weight=gross wt.−tare wt.

2. Final weight=weight recorded in step 6

3. Moisture Content(%)=[(gross wt−final wt.)/sample wt]×100.

Particle Size Analysis

A Malvern 2600D particle size analyzer with a PS/2 computer is used to analyze the particle size of the samples. A small amount (about 0.01 grams) of sample is placed in a 25 ml test tube and about 15 ml of acetone are added to it. The sample is dispersed in the acetone by using a vortex mixer. A transfer pipette is then used to add this diluted solution dropwise to the acetone filled cell of the analyzer. The sample is added until the obscuration is 0.2 to 0.3. The obscuration refers to the amount of light which is obscured by the sample because of diffraction and absorption. The instrument reads more accurately when the obscuration is 0.05 to 0.5 and preferably from 0.2 to 0.3 (20% to 30% of the light energy is reduced).

The apparatus is fitted with a 100 mm lens to determine the particle size of the paste. Particle sizes from 0.5 to 188 microns can be measured using a 100 mm lens. A magnetic stirrer is used to insure that the sample is being dispersed during the readings. Each sample is swept 250 times by the laser for each reading. Each sample was read a minimum of three times with a five (5) minute wait between each reading.

4. Viscosity Method

A Brookfield Viscometer (HAT series), 5C4-13R chamber with a 8C4-27 spindle is used. This arrangement consists of a spindle “bob” of 0.465 inches (1.12 cm). The inner diameter of the sample cell is 0.750 inches (1.87 cm). The instrument is calibrated at 65° C. and all samples are measured at 65° C.

A sample of 14.0 grams of lipid-based filling (non-aerated) is placed in the sample cell. The sample cell is then inserted in the jacketed cell holder. To compensate for heat losses through the tubings, etc., the water temperature entering the jacketed cell holder should be a few degrees higher than the desired sample temperature of 65° C. After the temperature of the sample has reached 65° C. the sample is pre-sheared for five minutes at 50 rpm. The speed is then changed to 100 rpm and a measurement taken after the dial reading settles to a constant value. A total of five scale readings are recorded for 100, 50, 20, 10 and 5 rpm. In general, the time before reading should be as set forth in Table I.

TABLE I

| Time Before Reading (Sec) | RPM |
|---|---|
| 3 | 100 |
| 6 | 50 |
| 15 | 20 |
| 30 | 10 |
| 60 | 5 |

The dial reading and rpm are converted into shear stress and shear rate values by multiplying the rpm and dial reading by 0.34 and 17, respectively. A plot of the square root of shear stress vs. the square root of shear rate results in a straight line. Readings where the dial pointer goes off scale are ignored. A least squares linear regression is made over the data to calculate the slope and intercept.

This data is used to calculate the Casson plastic viscosity, which is equal to the slope of the line squared. The Casson plastic viscosity is a measurement of the lipid-based filling's viscosity at an infinite shear rate. It accurately predicts the resistance to flow in pumping, moving or mixing situations. The Casson plastic viscosity is measured in poise.

5. % Fill Level Method

To determine the fill level, a 6 inch hollow dough tube is extruded or formed and weighed. Then, a 6 inch tube containing the filling is extruded or formed and weighed. The difference in weight between the two 6 inch tubes is the weight of the filling. The % filling is calculated as (weight of the filling/weight of the tube containing the filling)×100.

### EXAMPLES

The following examples are illustrative of the present invention but are not meant to be limiting thereof.

### Example 1

A reduced fat filled pretzel using a reduced fat peanut flavored filling is prepared following the following formulation and process.

| Pretzel Dough | |
|---|---|
| Ingredient | Wt (%) |
| Soft Wheat Pretzel Flour | 65.6 |
| Water | 29.5 |
| Corn Syrup (DE = 42) | 1.80 |
| Vegetable Shortening | 1.90 |
| Wheat Gluten | 0.75 |
| DATEM Emulsifier (Panodan SDK ®) | 0.34 |
| Active Dry Yeast | 0.11 |
| Filling | |
| Ingredient | Wt (%) |
| Defatted Peanut Flour | 37.61 |
| Olestra (Olean ®) | 27.2 |
| Peanut Paste | 17.7 |
| Sugar (Sucrose 12X) | 15 |
| Peanut Oil | 1.4 |
| Dry mixture of Vitamins A, D, and K (BASF | 0.09 |
| product #069751-3637) | |
| Salt | 1.0 |

The dough ingredients are combined in a dough mixer. The ingredients are mixed until well blended. The filling ingredients are combined in a ribbon mixer. The ingredients are mixed until well blended.

The dough and filling are co-extruded through a co-extruding die plate, such as that sold by Reading Bakery Systems. The extrudate is crimped and cut into cylindrical shaped nuggets. It is important that the ends of the nuggets are sealed.

The nuggets are then moved through a solution of approximately 0.70% NaOH and water at a temperature of approximately 180° F. The product is then baked at approximately 400° F. for 8 minutes and dried at a temperature of 250° F. for 12 minutes. The final moisture is about 4%

### Incorporation By Reference

All of the aforementioned patents, publications, and other references are herein incorporated by reference in their entirety. Also incorporated herein by reference are U.S. Provisional Application No. 60/242,609 (“Reduced Fat Lipid-Based Fillings,” Trout et al.), No. 60/242,608 (“Low Moisture, Reduced Fat, Lipid-Based Fillings,” Trout et al.), No. 60/242,607 (“Reduced Saturated Fat Lipid-Based Fillings,” Trout et al.), and No. 60/242,606 (“Low Fat Nut Spread Composition and Process for Making the Same,” Wong et al.), all filed Oct. 23, 2000.

What is claimed:

1. A filled snack comprising:
(a) an outer shell of from about 0.07 to about 0.3 inches after baking; and
(b) a lipid-based filling having a viscosity of less than about 10,000 cP before baking.

2. A filled snack comprising:
(a) an outer shell made from a dough comprising:
(1) from about 35% to about 74% flour;
(2) from about 0.05% to about 2% leavening;
(3) from about 0% to about 7% added protein, such that the outer shell comprises from about 2% to about 15% total protein; and
(4) from about 25% to about 35% added water; and
(b) a lipid-based filling having a viscosity of less than about 10,000 cP before baking.

3. A filled pretzel comprising:
(a) an outer shell made from a dough comprising:
(1) from about 50% to about 74% flour;
(2) from about 0.05% to about 2% leavening;
(3) from about 0% to about 7% added protein, such that the outer shell comprises from about 2% to about 15% total protein;
(4) from about 0.01% to about 7% added lipid;
(5) from about 25% to about 35% added water;
(6) from about 0% to about 3% malt;
(7) from about 0% to about 5% emulsifier;
(8) from about 0% to about 5% corn syrup; and
(9) from about 0% to about 10% flavoring; and
(b) a lipid-based filling having a viscosity of less than about 10,000 cP before baking.

4. A process for making a lipid-based nut filling comprising the steps of:
(1) providing a nut paste;
(2) defatting a first nut paste portion to form a defatted nut flour;
(3) milling the defatted nut flour to form a mono-modal nut solids flour; and
(4) refatting the mono-modal nut solids flour to form the nut filling by combining the mono-modal nut solids flour with a re-fatting ingredient selected from the group consisting of added oil, a second nut paste portion, or mixtures thereof.

5. A lipid-based nut filling made by the process of claim 4.

6. A filled snack comprising the lipid-based nut filling of claim 5.

7. A filled pretzel comprising:
(a) an outer shell made from a dough comprising:
(1) from about 50% to about 74% flour;
(2) from about 0.05% to about 2% leavening;
(3) from about 0% to about 7% added protein, such that the outer shell comprises from about 2% to about 15% total protein;
(4) from about 0.01% to about 7% added lipid;
(5) from about 25% to about 35% added water;
(6) from about 0% to about 3% malt;
(7) from about 0% to about 5% emulsifier;
(8) from about 0% to about 5% corn syrup; and
(9) from about 0% to about 10% flavoring; and
(b) the lipid-based nut filling of claim 5.

8. A process for making a filled snack, comprising the steps of:
(a) baking snack dough as a continuous filled tube to form a baked snack; and
(b) cutting said baked snack into snack pieces during or after baking.

9. The process of Claim 8, wherein said snack is the snack of claim 1, 2, 3, 6, or 7.
